(19) United States
(12) Patent Application Publication
(10) Pub. No.: US 2009/0186267 A1
(43) Pub. Date: Jul. 23, 2009

(54) Porous silicon particulates for lithium batteries

(76) Inventor: Terry N. Tiegs, Lenoir City, TN (US)

Correspondence Address: ROBERT J. LAUF, 998 W. OUTER DRIVE, OAK RIDGE, TN, 37830, US

(21) Appl. No.: 12/321,446

(22) Filed: Jan. 21, 2009

Related U.S. Application Data
(60) Provisional application No. 61/062,008, filed on Jan. 23, 2008.

(51) Int. Cl. H01M 10/24; H01M 4/58; H01M 2/14; H01M 4/66; H01M 4/26; H01M 4/24; B82B 3/00; B82B 1/00

(52) U.S. Cl. 429/129; 429/218.1; 429/219; 429/220; 429/221; 429/223; 429/231.5; 429/231.8; 502/101; 977/775; 977/784; 977/779; 977/742; 977/840; 977/932

(57) ABSTRACT

An anode structure for lithium batteries includes nanofeatured silicon particulates dispersed in a conductive network. The particulates are preferably made from metallurgical grade silicon powder via HF/HNO₃ acid treatment, yielding crystallite sizes from about 1 to 20 nm and pore sizes from about 1 to 100 nm. Surfaces of the particles may be terminated with selected chemical species to further modify the anode performance characteristics. The conductive network is preferably a carbonaceous material or composite, but it may alternatively contain conductive ceramics such as TiN or B₄C. The anode structure may further contain a current collector of copper or nickel mesh or foil.

### CROSS REFERENCE TO RELATED APPLICATION

This application claims the benefit of U.S. Provisional Patent Application Ser. No. 61/062,008 entitled, “Porous Silicon Particulates for Lithium Batteries” filed on Jan. 23, 2008, the entire disclosure of which is incorporated herein by reference.

### BACKGROUND OF THE INVENTION

1. Field of the Invention

The invention pertains to apparatus and methods for rechargeable batteries. More particularly the invention pertains to lithium ion batteries having nanostructured porous anode materials.

2. Description of Related Art

Lithium-ion batteries are of special interest for power sources because of their high energy density and long-lifetimes [see, e.g., S. Meghead and B. Scrosati, “Lithiumion Rechargeable Batteries,” J. Power Sources, 51, 79-104 (1994); and G.-A. Nazri and G. Pistoia, Lithium Batteries, Science and Technology, Kluwer Academic Pub. (2004)]. They are used extensively in consumer electronics and are envisioned as the batteries that would make electric vehicles viable. However, in spite of the recent commercial success, further development of Li-ion batteries is still needed. The high power applications require the electrode materials to possess higher specific capacities than today's batteries. At the present time, carbon-based materials (e.g. graphite) are utilized as the anode material [see, e.g., R. Kanno, et al, “Carbon as Negative Electrodes in Lithium Secondary Cells,” J. Power Sources, 26 [3-4] 535-543 (1989); and M. Mohri, et al, “Rechargeable Lithium Battery Based on Pyrolytic Carbons as a Negative Electrode,” J. Power Sources, 26 [34] 545-551 (1989)]. The theoretical capacity limit for intercalation of Li into the carbon is 372 mAh/g, which corresponds to a composition of LiC₆. However, the practical limit is on the order of 300-330 mAh/g. Consequently, to meet higher power requirements anticipated for applications like the electric vehicle, new materials with high capacity are necessary. This is an area of active research directed towards new materials and new morphologies [see, e.g., J. O. Besenhard, et al, “Will Advanced Lithium-alloy Anodes Have a Chance in Lithium-ion Batteries,” J. Power Sources, 68 [1] 87-90 (1997)]. Potential materials include Si, Sn, Sb, Pb, Al, Zn, Mg, and others. To date, the results as anode materials have been mixed.

In particular, Si has been studied extensively because it has one of the largest theoretical capacities at 4200 mAh/g, or more than an order of magnitude greater than the carbon-based materials. This capacity corresponds to a composition of Li_{4.4}Si. Numerous methods have been examined to utilize Si for the anode and they include Si particulates, Si alloys, thin films, and composites. However, all of these have been tested with generally disappointing results. The problem is concerned with charge-discharge cycling where the large accompanying volume change during lithiation of the silicon (>>100%) leads to rapid capacity fade due to loss of mechanical integrity and electronic conductivity. To date, some success has been observed with nano-Si particulates with carbon as a conducting matrix [see, e.g., Z. P. Guo, et al, “Silicon/Disordered Carbon Nanocomposites for Lithium-Ion Battery Anodes,” J. Electrochem. Soc., 152 [11] A2211-A2216 (2005); X.-W. Zhang, et al, “Electrochemical Performance of Lithium Ion Battery, Nano-silicon-based, Disordered Carbon Composite Anodes with Different Microstructures,” J. Power Sources, 125 [2] 206-213 (2004); H. Uono, et al, “Optimized Structure of Silicon/Carbon/Graphite Composites as an Anode Material for Li-ion Batteries,” J. Electrochem. Soc., 153 [9] A1708-A1713 (2006); H. Y. Lee and S.-M. Lee, “Carbon-coated Nano-Si Dispersed Oxides/graphite Composites as Anode Material for Lithium Ion Batteries,” Electrochem. Comm., 6 [5] 465-469 (2004); I.-S. Kim and P. N. Kumta, “High Capacity Si/C Nanocomposite Anodes for Li-ion Batteries,” J. Power Sources, 136 [1] 145-149 (2004); L. Chen, et al, “Spherical Nanostructured Si/C Composite Prepared by Spray Drying Technique for Lithium Ion Batteries Anode,” Mater. Sci. Eng. B, 131 [1-3] 186-190 (2006); and Z. Wang, et al, Nanosized Si—Ni Alloys Anode Prepared by Hydrogen Plasma-Metal Reaction for Secondary Lithium Batteries,” Mater. Chem. Phys., 100, 92-97 (2006)]. These prior discoveries are not directly related to the invention described herein, but are useful in understanding the general state of the art and some of the shortcomings found in conventional approaches.

A few studies have been reported that are more directly pertinent to the problem of adapting Si-based anode materials for Li-ion batteries. In one study, nano-sized Si was incorporated into porous carbon microbeads and they showed good cycling ability [as taught by B.-C. Kim, et al, “Cyclic Properties of Si—Cu/Carbon Nanocomposite Anodes for Li-ion Secondary Batteries,” J. Electrochem. Soc., 152 [3] A523-A526 (2005); and T. Hasegawa, et al, “Preparation of Carbon Gel Microspheres Containing Silicon Powder for Lithium Ion Battery Anodes,” Carbon, 42 [12-13] 2573-2579 (2004)]. In another reference which showed good cycling capabilities, mechanical alloying was used to introduce nanometer pores into a Si—Ni alloy [as taught by M.-S. Park, et al, “Si—Ni-Carbon Composite Synthesized Using High Energy Mechanical Milling for Use as an Anode in Lithium Ion Batteries,” Mater. Chem. Phys., 100, 496-502 (2006); and B.-C. Kim, et al, “Li-ion Battery Anode Properties of Si-Carbon Nanocomposites Fabricated by High Energy Multiring-type Mill,” Solid State Ionics, 172 [1-4] 33-37 (2004)]. Additionally, porous Si from electrochemical etching of Si single crystal with one-dimensional channels about 1-2 μm in diameter also exhibited improved cycling [as taught by H.-C. Shin, et al, “Porous Silicon Negative Electrodes for Rechargeable Lithium Batteries,” J. Power Sources, 139, 314-320 (2005)]. Finally, Si nanowires attached to a metal current collector have shown good cycling capacity [as taught by C. K. Chan, et al, High Performance Lithium Battery Anodes Using Silicon Nanowires,” Nature Nanotechnol., Advance Online Publication, 16 Dec. 2007]. However, each of the aforementioned approaches has its own characteristic attributes and drawbacks.

U.S. Pat. App. Pub. 20040214085 discloses the use of porous silicon particles prepared by quenching a molten alloy of silicon and a second element, then removing the second element with an acid or an alkali while not reacting with the silicon. The porous silicon particles are then used in Li-ion battery anodes.

Objects and Advantages

Objects of the present invention include the following: provision of an improved anode material for lithium ion batteries; provision of a lithium ion battery having improved cycling behavior; provision of a low cost method for manufacturing anodes for lithium ion batteries; provision of a reproducible method for making battery anode materials; and provision of a lithium ion battery having substantially higher discharge capacity than present day batteries. These and other objects and advantages of the invention will become apparent from consideration of the following specification.

### SUMMARY OF THE INVENTION

According to one aspect of the invention, an anode structure for a lithium battery comprises: nanofeatured silicon particulates having crystallite sizes from about 1 to 10 nm and pore sizes from about 1 to 100 nm, the nanofeatured particulates dispersed within a substantially conductive network.

According to another aspect of the invention, a lithium ion battery comprises: a cathode; a separator; an electrolyte; and, an anode comprising nanofeatured silicon particulates having crystallite sizes from about 1 to 10 nm and pore sizes from about 1 to 100 nm, the nanofeatured particulates dispersed within a substantially conductive network.

According to another aspect of the invention, a method for making an anode structure for a lithium battery comprising the steps of: preparing metallurgical grade silicon powder having a particle size from about 0.1 to 10 μm; acid treating the metallurgical grade silicon powder with a solution of HF and HNO₃ to form nanofeatured silicon particulates; and, dispersing the nanofeatured silicon particulates in a substantially conductive network.

### DETAILED DESCRIPTION OF THE INVENTION

Lithium-ion batteries enjoy widespread use; however, their electrical capacity is presently near the limit for the materials used for the anode. The invention uses an alternate material for the anode with a unique nano-featured morphology. New batteries developed from this novel anode would have potential discharge capacities up to an order of magnitude higher than today's Li-ion battery. Batteries with equivalent capacities could be a fraction of their present size and that would have a tremendous impact on new energy sources for portable and mobile devices.

The invention describes using Si as the anode material for Li-ion batteries. The inventive concept is based on the use of sponge-like porous silicon (PSi) particulates where the volume change that occurs during lithiation of the silicon is accommodated by the internal volume in the particulates. One preferred embodiment of the inventive Li-ion battery anode comprises sponge-like porous silicon particulates (PSi) dispersed in an electrically conductive network (preferably carbon).

To alleviate the cycling problem associated with Si anodes, the invention uses a novel sponge-like porous Si. The PSi has a unique morphology with a large pore volume within individual particles to accommodate the volume change. Because the volume change is mainly accommodated within the PSi structure, the mechanical integrity and electronic conductivity is maintained and no loss in battery capacity occurs during charge-discharge cycling.

The invention is based on Applicant's recognition that sponge-like Porous Si (PSi) with nanosized features and pores from the etching of silicon powders could have an ideal morphology to employ as anodes in Li-ion batteries where volume changes are accommodated internally. In addition, the relatively low cost of PSi obtained by this method and the fact that batteries would be fabricated in a similar fashion to those currently produced makes the entire process commercially attractive.

Most references in the literature on Porous Si refer to materials currently made using electrochemical anodization of single crystalline Si wafers in HF-ethanol solutions. In contrast, the present invention contemplates using porous sponge-like particles that are preferably manufactured by well known processes [see, e.g., D. Farrell, et al., “Silicon Nanosponge Particles,” U.S. Pat. App. Pub. 20060251561; D. Farrell, et al., “Porous Silicon Particles,” U.S. Pat. App. Pub. 20060251562; Q. Chen, et al., “Preparation and Characterization of Porous Silicon Powder,” Mater. Res. Bull., 33 [2] 293-297 (1998); Y. Li and I. Pavlovsky, “Method of Producing Silicon Nanoparticles from Stain-Etched Silicon Powder,” U.S. Pat. No. 7,244,513 (2007); and G. Anaple, et al., “Molecular Structure of Porous Si,” J. AppI. Phys., 78 [8] 4273-4275 (1995), the teachings of which are incorporated herein by reference in their entirety]. These processes yield a high surface area nanosponge material that contains nanocrystals and microporosity within a larger Si particle. The porous Si powders from metallurgical grade Si powder (as produced from process described in Farrell '561 and Farrell '562) have pore sizes in the range of 5 nm, particle sizes in the range of 0.1-10 μm and surface area up to 250 m²/g and are particularly suitable. The PSi described in Li and Pavlovsky, '513 has PSi purity from 80% to at most 100% (but more specifically 95 to 100%); PSi particle sizes from 1 nm to at most 1 mm (but more specifically from 0.1 micron to 10 microns); and PSi porosity ranges from 5 to 95% (but more specifically from at least 10% to at most 90%). Any of the PSi materials described in the aforementioned references in this paragraph are suitable for carrying out the present invention. Other methods to produce PSi morphologies may also be used to make Li-ion battery anodes.

One suitable method for making PSi powder for the present invention may be described as follows: As taught by D. Farrell, et al. in “Silicon Nanosponge Particles,” U.S. Pat. App. Pub. 20060251561, stain etching of silicon is known to create a porous morphology within the outermost layers of a silicon surface. Stain-etching is typically performed in an aqueous mixture of hydrofluoric and nitric acids. Similarly, in an example described in D. Farrell, et al., “Silicon Nanosponge Particles,” U.S. Pat. App. Pub. 20060251561, metallurgical grade silicon powder was treated in a 48% HF solution in water along with a 25% solution of HNO₃ in water added in steps. The resulting PSi powder was photoluminescent, had pore sizes in the range of 5 nm, particle sizes in the range of 4-10 μm and BET surface area from about 140 to 250 m²/g.

As taught in Farrell '561, metallurgical grade silicon powder is defined as powder produced from the raw silicon product of a silicon smelting and grinding process whereby the raw silicon product has not been further refined to make the silicon suitable for electronic, semiconducting, and photovoltaic applications. In other words, various impurities remain (particularly Al, Ca, and Fe) and it is believed that these impurities have a beneficial effect on the etching process.

### EXAMPLE

Sponge-like nanofeatured porous silicon particles were fabricated by reacting metallurgical grade silicon (Vesta Ceramics, Type 4E, average particle diameter 4 μm) with a HF-HNO₃ solution. The surface area was 124 m²/g and pore volume was 23%. The powder was then combined with citric acid in ethanol (1:1) as a carbon precursor. The slurry was dried and then fired to 700° C. to pyrolize the citric acid. Carbon yield from the citric acid was approximately 10 wt. %. To this mixture, 30 wt. % carbon black and 10 wt. % polyvinylidene fluoride (PVDF) was added. N-methyl pyrrolidone (NMP) was used to form a paste and this was applied to a copper foil current collector. Electrochemical testing showed the lithium ion intercalation capacity was approximately 3200 mAh/g.

Skilled artisans will appreciate that the inventive approach differs from that generally described in U.S. Pat. App. Pub. 20040214085. The present invention involves silicon particles that have been etched with HF-acid based solutions to form nanofeatured porous silicon particles. Nanofeatured means the silicon crystallite size is on the order of 1 to 10 nm with about a 5 nm average size. At this size range, the materials are photoluminescent under ultra violet light. If HF-acid-based solutions were used with the quenched particles described in U.S. Pat. App. Pub. 20040214085, the silicon would be etched along with the second element and a nanostructured porous structure would not be produced. It would not be nanofeatured or photoluminescent. The nanofeatured structure is important in that it provides sufficient surface area to give the materials a high capacity for lithium ion intercalation. Furthermore, the nanofeatured porous silicon produced by HF-based etching of metallurgical silicon is photoluminescent, with pore sizes in the range of 1-100 nm, particle sizes in the range of 0.1-20 μm and surface area up to 400 m²/g.

The as-prepared powder preferably has a hydrogen-terminated surface with about 2 hydrogen atoms bound to each surface Si [for background, see, e.g., V. Lysenko, et al, “Study of Porous Silicon Nanostructures as Hydrogen Reservoirs,” J. Phys. Chem. B, 109, 19711-19718 (2005)]. The hydrogen terminated surface also can be treated using solution chemistry to incorporate various elements onto the structure. Similar techniques have been used to deposit noble metals into electrochemically etched porous Si [for background, see, e.g., S. Chan, et al, “Methods for Uniform Metal Impregnation into a Nanoporous Material,” U.S. Pat. App. Pub. 20040161369].

Another feature of the present invention is that the porous Si can be given an additional solution treatment to terminate the surfaces with another element in place of the hydrogen. As an example, the powder could be treated with a cupric chloride solution to terminate the surfaces with Cu in place of the hydrogen. Cu has been used with Si anodes in previous studies with positive results [for background, see, e.g., J.-H. Kim, et al, “Addition of Cu for Carbon Coated Si-Based Composites as Anode Materials for Lithium-ion Batteries,” Electrochem. Comm., 7 [5] 557-561 (2005); and K. Wang, et al, “Si, Si/Cu Core in Carbon Shell Composite as Anode Material in Lithium-ion Batteries,” Solid State lonics, 178, 115-118 (2007)]. The treatment could also be used to attach other elements on the surface including (but not limited to) Ti, Pt, Pd, Zr, Fe, Co, Ni, Zn, Cr, Au, Ag, Al, Sn, and many others. Such treatments can be advantageous to utilization of the PSi in batteries. In particular, it could be useful for controlling the solid electrolyte interphase (commonly referred to as SEI) layer which in turn would benefit charge-discharge capacity behavior.

Metallurgical grade silicon posses a moderately good electrical conductivity and it is conceivable that the PSi could be used by itself for an anode in Li-ion batteries. However, fabrication of anodes will preferably involve combining the PSi with an electrically conductive network. The conductive network can be made of any electrically conductive material including carbon, metals (e.g., Cu, Ni, Ag, and Fe), or ceramics (e.g., TiN, and B₄C).

The most preferable choice for the conductive network would be carbon because of its low cost, low toxicity, and extensive prior use experience in Li-ion batteries. At the present time, carbon-based materials are utilized as electrically conductive networks with Li-ion battery anodes and cathodes. Carbon can be used either as a powder; as a precursor that would convert into a carbon-based material after a heat treatment; or even in the form of carbon nanotubes. In any case, the carbon will provide an electrically conductive network.

### EXAMPLE

Some exemplary carbon powders that could be used to form an electrically conductive network include graphite, carbon black, and acetylene black. The carbon powders would preferably be mixed homogeneously with the PSi particles. Carbon powders such as these are presently used in Li-ion batteries to provide electrical conductivity.

Electrically conductive metal and ceramic powders can be used in a similar manner to provide an electrically conductive network.

### EXAMPLE

Numerous types of carbonizable precursor materials can be used, such as sucrose, polyvinyl alcohol (PVA), phenol formaldehyde, polyacrylonitrile, polyvinyl chloride, polystyrene, and mesophase, naphthalene-based synthetic pitch. These have all been used in prior studies; however, it will be appreciated that many other carbonizable precursor materials are known in the art, and the use of any carbonizable precursors, alone or in combination is considered to lie within the spirit and scope of the present invention. Normally, the carbon precursor is dissolved in a liquid (e.g., water, alcohol, organic solvents, and mixtures thereof, mixed with the powder, and then dried. The result is a coating on the particle surface, which will form a carbon coating after heat treatment. Because the carbon precursors can be applied in a solution, carbon can also be deposited within the PSi structure which could be advantageous to the Li-ion battery application. How much carbon is deposited in the PSi pores will depend on the precursor concentration in the solution; the carbon yield from the precursor itself; and the extent of infiltration by the carbon precursor solution into the pore structure. The latter is dependent on the wetting behavior between the PSi and the precursor solution. Skilled artisans can readily determine suitable infiltration and carbonization treatments for particular applications through routine experimentation.

When carbon precursors are used, the composite materials are subjected to a thermal treatment to decompose the precursor and produce the carbon-based conductive network. Normally the heat treatment is done at 300-1000° C. in nitrogen, argon, or other non-reactive gas to decompose the carbon precursor. The heat treatment is done at a temperature below that which would allow the PSi to react with the carbon to form silicon carbide.

Carbon powders, carbon precursors, and carbon nanotubes can be used simultaneously in combination to optimize the performance of the Li-ion battery. It will be appreciated that the overall PSi:C ratio (wt. %) can vary somewhat as long as a conductive matrix is established.

### EXAMPLE

In the form described in the preceding example, (i.e. PSi particulates and an electrically conductive network), it is conceivable that a Li-ion battery anode could be fabricated. However, Applicant contemplates that in many cases the composite powders will preferably be combined with a binder (e.g., about 5-10 wt. % PVDF, sodium carboxymethylcellulose, polyaniline, polyamide imide, polypyrrole, or acrylic adhesives have been used in prior studies) and applied as a coating upon a current collector (e.g., copper or nickel foil or mesh). The coatings can vary depending on the final battery application requirements (such as the difference between consumer electronics, cell phones, and electric vehicles). Typically in Li-ion batteries, the coatings are 10 to 1000 μm thick.

The electrode assemblies can then dried and combined with a cathode (such as Li foil), a separator (such as Celgard 2400 manufactured by Hoechst Celanese Corp., Ltd.), and an electrolyte (e.g., 1 M LiPF₆ in a 1:1 combination of ethylene carbonate and diethyl carbonate or alternatively lithium bis(oxalate)borate (LiBOB)) as normally used in a Li-ion battery. In addition, the porous Si anode as described herein could be combined with advanced cathode materials (such as those from A123 Systems, Inc., Watertown, Mass., as further described in R. K. Holman, et al, “Coated Electrode Particles for Composite Electrodes and Electrochemical Cells,” U.S. Pat. No. 7,087,348) to produce superior battery performance.

I claim:

1. An anode structure for a lithium battery comprising:
nanofeatured silicon particulates having crystallite sizes from about 1 to 10 nm and pore sizes from about 1 to 100 nm, said nanofeatured particulates dispersed within a substantially conductive network.

2. The anode structure of claim 1 wherein said nanofeatured silicon particulates have an average pore size of about 5 nm, particle size in the range of about 0.1 to 10 μm, and BET surface area from about 140 to 400 m²/g.

3. The anode structure of claim 1 wherein selected surfaces of said nanofeatured silicon particulates are terminated with a species selected from the group consisting of: H, Ti, Pt, Pd, Zr, Fe, Co, Ni, Zn, Cu, Au, Ag, Al, and Sn.

4. The anode structure of claim 1 wherein said substantially conductive network comprises a material selected from the group consisting of: carbon, carbon black, graphite, acetylene black, carbonized pitch, carbonized sugars, carbonized alcohols, carbonized polymers, carbon nanotubes, TiN, and B₄C.

5. The anode structure of claim 1 further comprising a current collector.

6. The anode structure of claim 5 wherein said current collector is selected from the group consisting of: copper foil, copper mesh, nickel foil, and nickel mesh.

7. A lithium ion battery comprising:
a cathode;
a separator;
an electrolyte; and,
an anode comprising nanofeatured silicon particulates having crystallite sizes from about 1 to 10 nm and pore sizes from about 1 to 100 nm, said nanofeatured particulates dispersed within a substantially conductive network.

8. The lithium ion battery of claim 7 wherein said cathode comprises Li foil and said electrolyte comprises 1 M LiPF₆ in a 1:1 combination of ethylene carbonate and diethyl carbonate.

9. A method for making an anode structure for a lithium battery comprising the steps of:
preparing metallurgical grade silicon powder having a particle size from about 1 to 4 μm;
acid treating said metallurgical grade silicon powder with a solution of HF and HNO₃ to form nanofeatured silicon particulates; and, dispersing said nanofeatured silicon particulates in a substantially conductive network.

10. The method of claim 9 wherein said acid treating step comprises treating said powder in a 48% HF solution with the stepwise addition of a 25% HNO₃ solution so that said nanofeatured silicon particulate has a crystallite size from about 1 to 20 nm and pore size from about 1 to 20 nm.

11. The method of claim 9 wherein said nanofeatured silicon particulates have an average pore size of about 5 nm, particle size in the range of about 0.1 to 10 μm, and BET surface area from about 140 to 400 m²/g.

12. The method of claim 9 further comprising the step of:
functionalizing selected surfaces of said nanofeatured silicon particulates by terminating said surfaces with a species selected from the group consisting of: H, Ti, Pt, Pd, Zr, Fe, Co, Ni, Zn, Cu, Au, Ag, Al, and Sn.

13. The method of claim 9 wherein said substantially conductive network comprises a material selected from the group consisting of: carbon, carbon black, graphite, acetylene black, carbonized pitch, carbonized sugars, carbonized alcohols, carbonized polymers, carbon nanotubes, TiN, and B₄C.
